(19) United States
(12) Patent Application Publication
(10) Pub. No.: US 2023/0341561 A1
(43) Pub. Date: Oct. 26, 2023

(54) Method for Detecting a Manipulated or Falsified GNSS Signal

(71) Applicant: Robert Bosch GmbH, Stuttgart (DE)

(72) Inventors: Markus Langer, Sachsenheim (DE); Peter Zobel, Stuttgart (DE); Lena Schindler, Schwieberdingen (DE); Marco Limberger, Appenweier-Urloffen (DE)

(21) Appl. No.: 18/044,988

(22) PCT Filed: Sep. 16, 2021
(86) PCT No.: PCT/EP2021/075478

§ 371 Date: Mar. 12, 2023

(30) Foreign Application Priority Data
Sep. 24, 2020 (DE) 10 2020 212 033.1

(51) Int. Cl. G01S 19/21

(52) U.S. Cl. CPC G01S 19/215

(57) ABSTRACT

A method for detecting a manipulated or falsified GNSS signal is disclosed The method includes a) receiving a GNSS signal; b) analyzing the GNSS signal in order to determine at least one signal property and at least one satellite property from the GNSS signal; c) comparing the determined at least one signal property with at least one known signal property which is determined as a function of the detected at least one satellite property; and d) detecting a manipulated or falsified GNSS signal if there is a discrepancy between the determined signal property and the known signal property.

The invention relates to a method for detecting a manipulated or falsified GNSS signal, to a computer program for performing the method, to a machine-readable storage medium on which the computer program is stored, and to a system for a vehicle, wherein the system is configured for performing the method. The invention may in particular be used in GNSS-based localization systems for autonomous or semi-autonomous driving.

### PRIOR ART

The generation and transmission of manipulated and/or falsified GNSS signals is also commonly referred to as “spoofing.” Spoofing occurs in particular with the objective of misleading a GNSS receiver, possibly without the GNSS receiver noticing the attack. Spoofing is technically challenging since the complex GNSS signal structures need to be replicated, typically for multiple GNSS signals in parallel. The so-called meaconing is a sub-category of spoofing and relates to the retransmission of received GNSS signals. This avoids the effort of implementing the generation of the complex GNSS signal structures and also results in the GNSS receiver providing erroneous PNT information (position, navigation, time) since the reception and re-emission process changes the relative delays of the GNSS signals as seen by the receiver, in comparison to the relative delays of the authentic GNSS signals at the location of the receiver.

There are some standard approaches that, as a side effect, help overcome spoofing, e.g., by processing a sensor fusion with IMU or implementing residue-based monitoring. However, no corresponding techniques are known, in particular in the automotive field. Depending on the effort, criminal energy and financial opportunities of an attacker, there is in principle always the risk that a navigation system can be damaged by spoofing. However, there is the aim to keep the risk as low as possible.

### DISCLOSURE OF THE INVENTION

Claim 1 herein proposes a method for detecting a manipulated or falsified GNSS signal, comprising at least the following steps:
a) receiving a GNSS signal,
b) analyzing the GNSS signal in order to determine at least one signal property and at least one satellite property from the GNSS signal,
c) comparing the determined at least one signal property with at least one known signal property which is determined as a function of the detected at least one satellite property,
d) detecting a manipulated or falsified GNSS signal if there is a discrepancy between the determined signal property and the known signal property.

For example, steps a), b), c) and d) may be performed at least once and/or repeatedly in the sequence given in order to perform the method. Furthermore, steps a), b), c) and d), in particular steps c) and d) may be performed at least in part in parallel or simultaneously. In particular, step a) may be performed by a vehicle or by means of a GNSS receiver and/or a GNSS sensor of a vehicle. Steps b), c) and/or d) may also be performed by the vehicle and/or at least in part externally to the vehicle, e.g., by a superordinate management device capable of receiving data from multiple vehicles.

The method is in particular used for (machine) detection of GNSS spoofing and/or meaconing. In this context, the manipulated or falsified GNSS signal may, for example, be such a signal that is artificially generated by a GNSS signal generator (external to the satellite) and is in particular sent to GNSS receivers as an alternative or in addition to (original) satellite signals. The GNSS signal generator can, for example, be used to fully simulate GNSS signals and/or add at least one signal to received GNSS signals in a meaconing scenario. By way of example, the method may help to detect meaconing attacks in which received GNSS signals are forwarded. The method is however not limited thereto. Rather, the method can advantageously help to detect whether spoofing of GNSS signals is currently (generally) taking place.

The method is in particular used to detect a manipulated or falsified GNSS signal as part of a (self-)localization of a (motor) vehicle based (at least also) on GNSS data. In this context, the method in particular helps to improve the accuracy and/or reliability of the position result of the vehicle position. In particular, any present manipulation of the vehicle position can be detected or discovered from the self-localization. For example, the vehicle may be an automobile, which is preferably configured for at least partially automated and/or autonomous driving operation.

In step a), a GNSS signal is received. In this case, one or more (original) GNSS signals may in principle be received from one or more GNSS satellites (e.g., from satellites of the GPS, GLONASS, Galileo, Beidou, etc. services). Furthermore, manipulated or falsified GNSS signals may be received, e.g., those sent by a spoofing device.

In step b), the GNSS signal is analyzed in order to determine at least one signal property and at least one satellite property from the GNSS signal. The signal property may, for example, be the (received) carrier wave frequency/ies. The satellite property may, for example, be the series of the relevant satellite and/or the availability of carrier wave frequencies (L1, L2C, etc.) in the relevant satellite.

In their navigation data (GNSS data or GNSS satellite data), GNSS satellites usually transmit information about the series of the relevant (sending) satellite and/or about which GNSS signals (e.g., which frequencies) are or should be present. For example, older GPS satellites do not transmit a civil signal at the second frequency (L2C). This information is usually communicated via the navigation data. By way of example, the series or the age of the satellite can thus represent an advantageous satellite property.

For example, a navigation data handler or GNSS signal handler of a system also described herein may decode the navigation data of the satellites or the received signals and therefrom derive the at least one signal property and/or at least one satellite property (e.g., the series of the satellite or of the possibly supposed satellite). Furthermore, at least one known signal property may be determined as a function of the detected at least one satellite property. The known signal property may, for example, relate to a signal characteristic, e.g., that a particular series does not transmit a civil signal at the second frequency (L2C). Corresponding known signal properties or signal characteristics that occur with particular satellite properties may, for example, be stored (encoded) (in a fixed or updatable manner) in the system also described herein and/or may be obtained via a preferably wireless connection (e.g., radio-based Internet connection).

In step c), the determined at least one signal property is compared with at least one known signal property which is determined as a function of the detected at least one satellite property. For example, a comparison may be made between carrier wave frequencies, in particular between at least one carrier wave frequency which is received (or at which reception takes place) and at least one carrier wave frequency which should or should not (usually) be received (or at which reception should or should not take place) in the case of the relevant satellite series.

On the basis of the above example, a known signal property determined as a function of the series may, for example, be that no civil signal is transmitted at the second frequency (L2C).

A spoofing monitor of the system also described herein may be configured to compare the known signal property/ies or

signal characteristic(s) with the received signals. The spoofing monitor may issue a spoofing warning if, for example, a discrepancy between determined signal property and known signal property has been detected, in particular if an impossible signal has been received. This information may subsequently be used in the position calculation and/or for status information.

In step d), a manipulated or falsified GNSS signal is detected if there is a discrepancy between the determined signal property and the known signal property. In other words, the discrepancy relates in particular to a deviation between the determined signal property and the known signal property. If a manipulated or falsified GNSS signal has been detected, it may, for example, be eliminated, in particular be excluded from being used in a localization of a vehicle position.

Spoofing may, for example, be detected if the spoofer has not consistently generated all signals and associated navigation data to the effect that (on the basis of the above example) such a signal is received from, for example, a (supposed) satellite that cannot transmit at a particular frequency.

According to one advantageous embodiment, it is proposed that in step a), the GNSS signal is received by a GNSS sensor of a vehicle. The GNSS sensor may, for example, be arranged in and/or on the vehicle.

According to a further advantageous embodiment, it is proposed that the at least one satellite property comprises at least one of the following properties: satellite type, satellite model, satellite series. Preferably, the satellite property relates to the satellite series.

According to a further advantageous embodiment, it is proposed that the at least one known signal property relates to at least one or the at least one frequency of the signal. The frequency relates in particular to at least one carrier wave frequency of the signal, which, by way of example, should or should not (usually) be received (or at which reception should or should not take place) in the case of the relevant satellite series.

According to a further advantageous embodiment, it is proposed that a manipulated or falsified GNSS signal is detected if a GNSS signal is received at a frequency at which the supposedly sending GNSS satellite does not transmit. In particular, a manipulated or falsified GNSS signal may be detected if a GNSS signal is received at or with a carrier wave frequency at which the supposedly sending GNSS satellite does not transmit.

In a further aspect, a computer program for performing a method presented herein is proposed. In other words, this relates in particular to a computer program (product) comprising instructions that, when the program is executed by a computer, cause the computer to execute a method described herein.

According to a further aspect, a machine-readable storage medium is proposed, in which the computer program proposed herein is kept or stored. The machine-readable storage medium is routinely a computer-readable data carrier.

A system for a (motor) vehicle, wherein the system is configured to perform a method described herein. The system may, for example, comprise a computer and/or a controller that can execute instructions to execute the method. For this purpose, the computer or the controller can, for example, execute the specified computer program. For example, the computer or the controller may access the specified storage medium in order to execute the computer program.

The system may, for example, comprise a GNSS sensor for receiving GNSS signals. The system may, for example, (furthermore) comprise a navigation data handler or GNSS signal handler and/or a spoofing monitor. The system may (in addition) comprise a localization device, which can determine a vehicle's own position by at least also using received GNSS signals (not detected as manipulated or falsified). In the process, the localization device may, for example, merge GNSS data with further data from sensors of the vehicle, e.g., environmental sensor data from environmental sensors of the vehicle.

The system may, for example, be a component of a movement and position sensor, which, in particular, can or is arranged in or on a vehicle, or may be connected to such a sensor for information exchange. In this context, it may be provided that, for example, the GNSS sensor and/or the localization device are components of the movement and position sensor. Furthermore, it may (alternatively) be provided that the system comprises a movement and position sensor, which in this case may, for example, comprise the GNSS sensor and/or the localization device.

The details, features and advantageous embodiments discussed in connection with the method may also occur in the computer program presented herein and/or in the storage medium and/or in the system, and vice versa. In this respect, reference is made in full to the statements there regarding the more detailed characterization of the features.

The solution presented herein and its technical environment are explained in further detail below with reference to the figures. It should be noted that the invention is not to be limited by the exemplary embodiments shown. In particular, unless explicitly shown otherwise, it is also possible to extract partial aspects of the facts explained in the figures and to combine them with other components and/or findings from other figures and/or the present description. Schematically shown are:

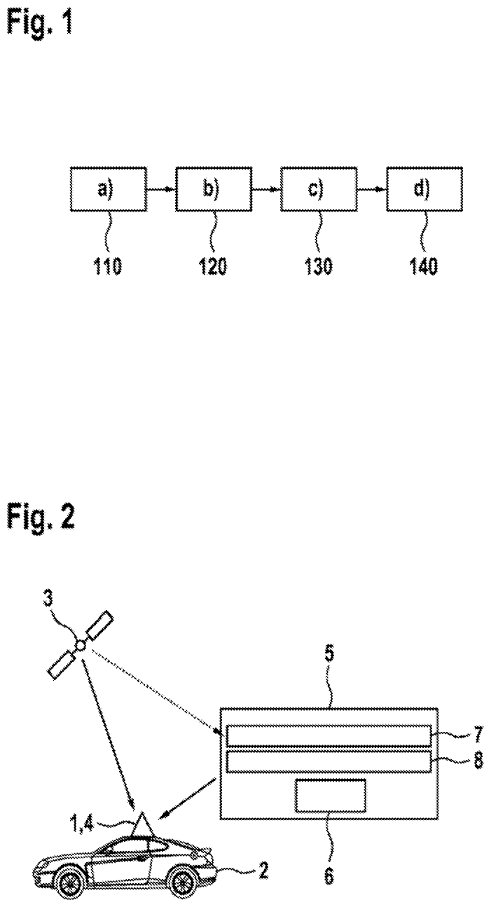

FIG. 1: an exemplary flow of the method presented herein, and

FIG. 2: an example of a system described herein for a vehicle.

FIG. 1 schematically shows an exemplary flow of the method presented herein for detecting a manipulated or falsified GNSS signal. The sequence of steps a), b), c) and d) shown with the blocks 110, 120, 130 and 140 is exemplary and may, for example, be performed at least once in the shown sequence in order to perform the method.

In block 110, according to step a), a GNSS signal is received. The GNSS signal may, by way of example, be received by a GNSS sensor 1 of a vehicle 2 (cf. FIG. 2).

In block 120, according to step b), the GNSS signal is analyzed in order to determine at least one signal property and at least one satellite property from the GNSS signal. For example, the at least one satellite property may comprise at least one of the following properties: satellite type, satellite model, satellite series.

In block 130, according to step c), the determined at least one signal property is compared with at least one known signal property which is determined as a function of the detected at least one satellite property. For example, the at least one known signal property may relate to the frequency of the signal.

In block 140, according to step d), a manipulated or falsified GNSS signal is detected if there is a discrepancy between the determined signal property and the known signal property. For example, a manipulated or falsified GNSS signal may be detected if a GNSS signal is received at a frequency at which the supposedly sending GNSS satellite 3 does not transmit.

FIG. 2 schematically shows an example of a system 4 described herein for a vehicle 2. The system 4 is configured to perform the method described in connection with FIG. 1.

In the exemplary scenario illustrated in FIG. 2, there is a spoofing device 5 having a signal generator 6. Furthermore, the spoofing device 5 comprises, for example, a module 7, which can receive a GNSS signal transmitted by a GNSS satellite 3 (e.g., GPS, GLONASS, Galileo or Beidou) and can add falsified signals or signal components thereto and/or can manipulate the signal content of the GNSS signal. In addition, the spoofing device 5 here comprises, by way of example, a module 8 which can generate its own falsified GNSS signal. For this purpose, the modules 7, 8 can each access the signal generator 6.

The system 4 is, for example, arranged in or on a vehicle 2. A GNSS sensor 1 of the system 4 can receive both original GNSS signals from GNSS satellites 3 and manipulated and/or falsified GNSS signals from the spoofing device 5. The system 4 may perform a GNSS-based localization of the vehicle, wherein, using the described method, the signals coming from the spoofing device 5 may be detected and advantageously excluded from the localization.

The method thus advantageously helps to ensure that the risk that a navigation system can be damaged by spoofing can be kept as low as possible or can at least be reduced.

1. A method for detecting a manipulated or falsified GNSS signal, comprising:
a) receiving a GNSS signal;
b) analyzing the GNSS signal in order to determine at least one signal property and at least one satellite property from the GNSS signal,
c) comparing the determined at least one signal property with at least one known signal property which is determined as a function of the detected at least one satellite property, and
d) detecting a manipulated or falsified GNSS signal if there is a discrepancy between the determined signal property and the known signal property.

2. The method according to claim 1:
wherein, in step a), the GNSS signal is received by a GNSS sensor of a vehicle.

3. The method according to claim 1, wherein the at least one satellite property comprises at least one of the following properties: satellite type, satellite model, satellite series.

4. The method according to claim 1, wherein the at least one known signal property relates to at least one frequency of the signal.

5. The method according to claim 1, wherein a manipulated or falsified GNSS signal is detected if a GNSS signal is received at a frequency at which the supposedly sending GNSS satellite does not transmit.

6. A computer program for performing a method according to claim 1.

7. A machine-readable storage medium on which the computer program according to claim 6 is stored.

8. A system for a vehicle, wherein the system is configured to perform a method according to claim 1.
